(19) United States
(12) Patent Application Publication
(10) Pub. No.: US 2024/0244102 A1
(43) Pub. Date: Jul. 18, 2024

(54) SYSTEM AND METHOD FOR WEB COMPONENTS INTERACTION AND DATA UPDATING

(71) Applicant: Upswot Inc., Wilmington, DE (US)

(72) Inventors: Kyrylo PROKOPCHUK, Kyiv (UA); Yanis YAVORSKYI, Pavlograd (UA); Ustymenko YEVHENII, Vyshhorod city (UA); Yevhen ANDRIIENKO, Kyiv (UA)

(73) Assignee: Upswot Inc., Wilmington, DE (US)

(21) Appl. No.: 18/155,022

(22) Filed: Jan. 16, 2023

(51) Int. Cl. H04L 67/02; G06F 8/65; H04L 67/141

(52) U.S. Cl. CPC H04L 67/02; G06F 8/65; H04L 67/141

(57) ABSTRACT

A system and method of web components interaction and data updating comprising establishing a connection between the server and web components, creation of data change in at least one of the web components, transferring updated data from at least one of the web components to the server, transferring data from the server to the at least one of another web components using WebSocket computer communications protocol. The method comprising the identification of web components and result of execution of algorithm received from identified web component and web components are configured to update data only after identifying that updated data is a result of execution of identified algorithm received from identified web component.

### TECHNICAL FIELD

The present invention relates to the field of information systems and technologies and more particularly, to communications networks and web applications available over communications networks.

### BACKGROUND

Services provided in different fields have become highly integrated into any kind of computing systems or communication devices. Software applications are designed to quickly and efficiently process massive amounts of information and benefit from using independent modules such as web components.

With the growing use of the Internet and online services, such as online financial services, the embedded-finance and banking-as-a-service, customers desire mechanisms and services which provide effective interaction between several web components.

Therefore, WebSockets are used with a set of function calls defined by a socket's application programming interface (API).

As users become mobile and applications migrate to SaaS and public clouds, there was a need to add real-time functionality to web components and widgets and the possibility for real-time updates in SaaS solutions

There are known methods and systems for web components interaction and data updating, which are directed at providing updatable web service components.

However, such systems and methods have significant disadvantages:
they do not allow to achieve effective updating of the web components which are easily integrated into other products;
do not allow fast updates of several web components.

Known methods for web components interaction and data updating which comprise sending a request by user to the server. After receiving a request server sends the response to the client, and each request is associated with a corresponding response. After sending the response the connection gets closed, each request establishes a new connection to the server every time, and after getting the response the connection gets terminated.

The standard approach is time-consuming and requires waiting for some event to occur due to the constant call to the resource API, which negatively affects the resources of both the server and the client.

There is also a need to send data directly from the server to the web component when necessary.

It is common to use several web components on a page (dashboard), and it becomes essential to propose an effective data exchange method or system enabling it to perform the process in real-time and simultaneously maintain the stability of a network's infrastructure.

An effective real-time data update method and system are essential for maintaining operational efficiency and the stability of the network infrastructure.

A need exists for methods and systems of web components interaction and updating, which are easily integrated into other products in which all related data in all modules and/or widgets on the page should be updated after data change in one of the modules.

### SUMMARY OF THE INVENTION

According to exemplary embodiments, methods and systems for web components interaction and data updating are provided.

It should be appreciated that the above high-level summary is provided only for the general introduction of certain concepts in the Detailed Description. All concepts and methods are the subjects of detailed explanation below in the particular document. Notable that this summary is not intended to identify key features or methods of this disclosure nor to limit the scope of the invention.

A system of web components interaction and data updating comprising one or more processors, one or more computer-readable memories, one or more computer-readable storage mediums, at least one server configured to establish a connection with web components and program instructions stored on at least one of the computer-readable storage mediums for execution by at least one of the processors via at least one of the computer-readable memories,
the program instructions to transfer data from the web components to the server and receive responses from the server using WebSocket computer communications protocol, program instructions to send messages with updated data from the server to each of the web components after the data change in the at least one of the web components or at least one of the servers.

The web component represents a software component configured to retrieve user information from an information system in response to user action and to show information based on user input and/or events in the information system.

According to the embodiments of the invention the system of web components interaction and data updating wherein program instructions are configured to identify web components, to identify the result of execution of algorithm received from identified web component. Web components are configured to update data only after identifying that updated data is a result of the execution of identified algorithm received from identified web component.

A (e.g., computer-implemented) method of web components interaction and data updating at a computer system in a computer networking environment, the method comprising establishing a connection between at least one server and the at least one of the web components, creation of data change at at least one of the web components, transferring updated data from the at least one of the web components to the server, transferring data from the server to the at least one of another web components using WebSocket computer communications protocol.

The method, according to one of the embodiments of the invention, comprises establishing a two-way interactive communication session between web components and server by WebSocket computer communications protocol, creation of data change in at least one web component, sending a message with updated data from the web component to the server and receiving responses from the server to the web component wherein data is updated at each of the web components using WebSocket computer communications protocol after data change in at least one of the web components.

The method may further comprise entering data in at least one of the web components by at least one User, creating the data change in at least one web component, transferring updated data from at least one of the web components to the server using the HTTP protocol, executing of the algorithm using the processing device at the server, wherein the algorithm is configured to update data at the server, transferring of the algorithm result from server to another web component using WebSocket computer communications protocol.

Further, the method may comprise the creation of the data change in at least one web component by at least one User, receiving the updated data wherein data is received by at least one of another user which is using the same web component.

In another embodiment the method may comprise entering data in at least one of the web components by at least one User, creating the data change in at least one web component, and executing the algorithm using the processing device at the server, wherein the algorithm is configured to retrieve data of each of the web component's data change and transfer updated data to all of the other web components using WebSocket computer communications protocol.

The algorithm may be configured to transfer updated data to all of the web components using the WebSocket computer communications protocol.

The method may further comprise configuring the web components for listening to the server wherein identification of the web components is carried out. Each of the web components is configured to receive the data only after identifying that updated data is a result of the execution of identified algorithm received from identified web component.

In the alternative embodiment, the method may comprise executing the algorithm using the processing device, transferring the result of algorithm execution to the web component of the widget, processing the result of algorithm execution received from the identified block of the server, identifying by web component that received data is a result of the execution of the algorithm received from the identified block of the server and the data for the execution of the algorithm is received from the identified web component.

The identification of the web components may be carried out with a unique identification key.

The identification key may be generated at the frontend side and transmitted to the backend side using WebSocket computer communications protocol.

The method may comprise performing data exchange between all web components in real time. Web components may be configured to connect with the server and work across various environments and various browsers

One WebSocket connection may be used for two or more widgets.

WebSocket connection may be established with each of the two or more widgets.

Data changes in web components may be performed by several users. For example, when the same web component is used by several users. In case of data change created by one user, it may influence the state of the web component of another user.

In embodiments of the invention, all related data in all web components (modules and/or widgets) on the user's page are updated simultaneously without creating additional connections after data exchange in one of the modules through WebSockets computer communications protocol. Therefore, WebSockets is considered to be a good solution for services that require continuous data exchange. While those connections are requested, they remain active throughout their lifetime.

The low-latency update of content in widgets is made possible by the combination of web components and WebSockets technology. WebSockets open a two-way interactive communication session between the user's browser and a server. Messages can be sent to a server and receive responses without having to poll the server for a reply.

The combination of web components technology with WebSockets accelerates and simplifies the implementation of a product into other products and allows it to be independent of any framework. It allows receiving real-time updates due to the combination of WebSockets and web components which are easily integrated into other products where all related data in all modules and/or widgets on the page should be updated.

Application WebSocket computer communications protocol for web components interaction in combination with backend data block at the server improves the accuracy of data updating and helps to update data in all web components faster and more efficiently.

This technology allows as quickly as possible to implement web components into the product, for example, a bank dashboard, or any SaaS solution product, and to receive updates in real-time. It also allows the implemented product to work with the least loss of speed and minimize the load on the server. This solution can be effectively implemented in SaaS products such as online financial services products, the embedded-finance or banking-as-a-service.

The invention enables end-users to seamlessly connect applications and share data while extending functionality by exchanging data between components using web-socket technology.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a functional block diagram of a computing system 100 for implementing the method disclosed herein, in accordance with one or more embodiments described herein.

FIG. 2 illustrates a flowchart of method 200 of web components interaction and data updating, in accordance with one or more embodiments described herein.

FIG. 3 illustrates a flowchart of method 300 of web components interaction and data updating, in accordance with one or more embodiments described herein.

FIG. 4 illustrates a flowchart of method 400 of web components interaction and data updating, in accordance with one or more embodiments described herein.

FIG. 5 illustrates a flowchart of method 500 of web components interaction and data updating, in accordance with one or more embodiments described herein.

FIG. 6 illustrates a circuit diagram of one aspect of a computing system/device/controller 1000 that works in conjunction with the elements of the present disclosure.

### DETAILED DESCRIPTION OF PREFERRED EMBODIMENTS

This disclosure is not limited to the particular systems, devices and methods described, as these may vary. The terminology used in the description is for the purpose of describing the particular versions or embodiments only, and is not intended to limit the scope. Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

Descriptions of well-known starting materials, processing techniques, components and equipment may be omitted so as not to unnecessarily obscure the invention in detail. It should be understood, however, that the detailed description and the specific examples, while indicating (e.g., preferred) embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk drive, flash drive or other memory), hardware circuitry or the like, or any combination.

Before discussing specific embodiments, embodiments of a hardware architecture for implementing certain embodiments is described herein. One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylus, etc.) or the like. In various embodiments, the computer has access to at least one database over the network.

ROM, RAM and HD are computer memories for storing data and computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

The following terms shall have, for the purposes of this application, the respective meanings set forth below.

A “user” or the like refers to one or more entities or people using any of the components and/or elements thereof as described herein. In some embodiments, the user may be a user of an electronic device. In other embodiments, the user may be a user of a computing device. Users described herein are generally either creators of content, managers of content, merchants, and/or consumers. For example, a user can be an administrator, a developer, a group of individuals, a content provider, a consumer, a merchant, a representative of another entity described herein, and/or the like.

An “electronic device” refers to a device that includes a processor and a tangible, computer-readable memory or storage device. The memory may contain programming instructions that, when executed by the processing device, cause the device to perform one or more operations according to the programming instructions. Examples of electronic devices include personal computers, supercomputers, gaming systems, televisions, mobile devices, medical devices, recording devices, and/or the like.

A “mobile device” or the like refers to an electronic device that is generally portable in size and nature or is capable of being operated while in transport. Accordingly, a user may transport a mobile device with relative ease. Examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, and the like.

A “computing device” or the like is an electronic device, such as a computer, a processor, a memory, and/or any other component, device or system that performs one or more operations according to one or more programming instructions.

A “user interface” or the like is an interface which allows a user to interact with a computer or computer system. A user interface may generally provide information or data to the user and/or receive information or data from the user. The user interface may enable input from a user to be received by the computer and may provide output to the user from the computer. Accordingly, the user interface may allow a user to control or manipulate a computer and may allow the computer to indicate the effects of the user's control or manipulation. The display of data or information on a display or a graphical user interface is a non-limiting example of providing information to a user. The receiving of data through a keyboard, mouse, trackball, touchpad, pointing stick, graphics tablet, joystick, gamepad, webcam, headset, gear sticks, steering wheel, pedals, wired glove, dance pad, remote control, and accelerometer are non-limiting examples of user interface components which enable the receiving of information or data from a user.

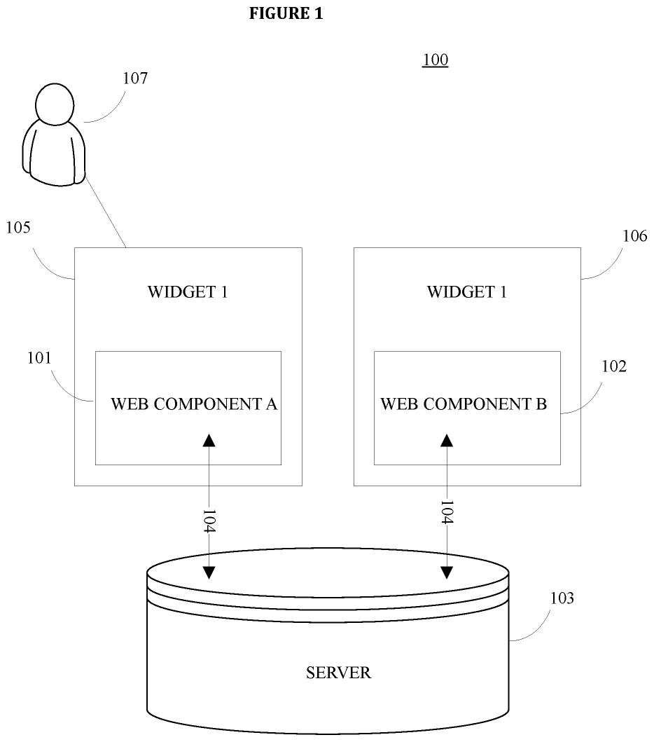

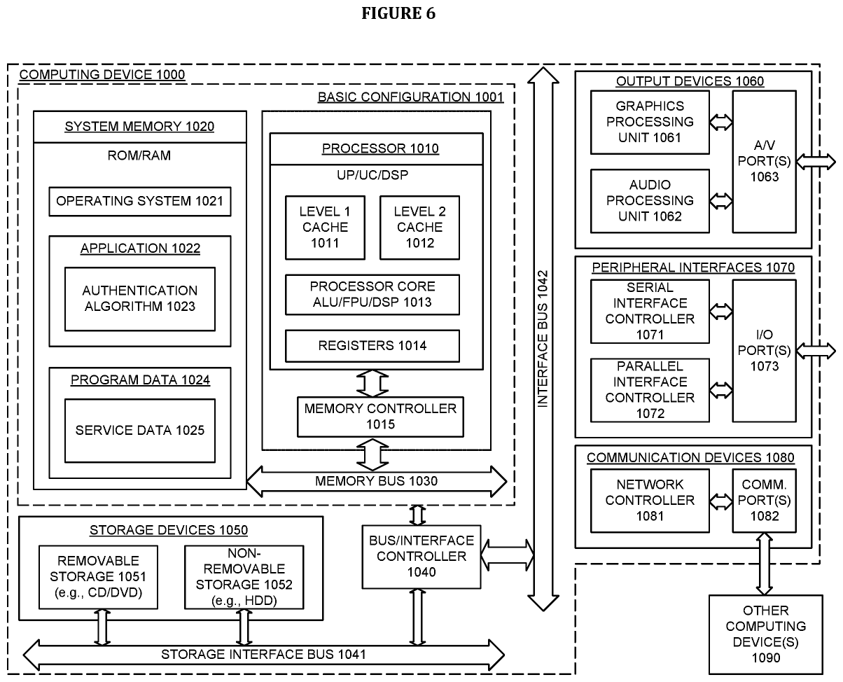

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations include, but is not limited to: “for example,” “for instance,” “particularly,” “more particularly,” “e.g.,” “in one embodiment.” The functions of the various devices described herein with respect to at least the FIG. 1 represents an improvement in the functionality of general computing devices known in the art, and thus teach significantly more than existing technology, by providing an ability to efficiently communicate (e.g., via the web). Such devices may include a plurality of components, such as the components described herein with respect to at least FIG. 6. The functions of the various devices described herein with respect to at least FIG. 1 may also provide entities with an ability to efficiently communicate (e.g., via the web) that were previously nonexistent and would not be possible without the various computing devices, server devices and electronic devices herein. Such efficientive communication (e.g., via the web) would not be feasible without implementation of the devices described herein.

Furthermore, embodiments described herein are directed to providing methods and systems of web components interaction and data updating.

As should be understood, any embodiment of the invention may incorporate only one or a plurality (or all) of the above-disclosed aspects of the disclosure and may contain only one or a majority of the above-disclosed features. Furthermore, any embodiment discussed and identified as being “preferred” is considered part of the best mode contemplated for carrying out the embodiments of the present disclosure. Other embodiments also may be considered for additional illustrative purposes in providing complete and enabling disclosure. Some embodiments, such as adaptations, variations, modifications, and equivalent arrangements, will be implicitly disclosed by the embodiments described herein and fall within the scope of the present disclosure.

Accordingly, it is to be understood that this disclosure is illustrative and exemplary of the present disclosure and is made merely to provide a complete and enabling disclosure. The detailed disclosure herein of one or more embodiments is not intended to limit the scope of patent protection afforded in any claim of a patent issuing here from, which scope is to be defined by the claims and the equivalents thereof. It is not intended that the scope of patent protection be determined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of different processes or methods may be shown and described as being in a sequence or temporal order. The steps of any such processes or methods are not limited to being carried out in any particular sequence or order, absent an indication otherwise. Indeed, the steps in such processes or methods generally may be carried out in various arrangements and orders while still falling within the scope of the present disclosure.

Exemplary embodiments are described below concerning (e.g., functional) block diagrams and/or flowchart illustrations of methods, apparatus (systems and/or devices), and/or computer program products. It is understood that a block of the block diagrams and/or flowchart illustrations, and combinations of blocks in the block diagrams and/or flowchart illustrations, can or may be implemented by computer program instructions.

These computer program instructions may be provided to a processor of a general purpose computer, particular purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions that implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.). Furthermore, exemplary embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

Embodiments of the present invention may comprise or utilize a special-purpose or the general-purpose computer including computer hardware, as discussed in greater detail below. Embodiments within the scope of the present invention also include physical and other computer-readable storage media for carrying or storing computer-executable instructions and/or data structures. Such computer-readable media can be any available media that a general-purpose or particular-purpose computer system can access. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: physical storage media and transmission media.

The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the document or other medium, then compiled, interpreted, or otherwise processed in a suitable manner, if necessary, and then stored in a computer memory.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

The invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. Program modules may be located in both local and remote memory storage devices in a distributed system environment.

The method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of one or more client devices and/or the server computer may include, a desktop computer, a laptop computer, a tablet computer, a personal digital assistant, a portable electronic device, a wearable computer, a smartphone, an Internet of Things (IOT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, assessing, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. One or more external devices may include, for example, but are not limited to, a client device, a third-party database, a public database, a private database, and so on. Further, the communication device may be configured for communicating with one or more external devices over one or more communication channels. Further, one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. The storage device may be configured to provide reliable digital information storage. Accordingly, in some embodiments, the storage device may be based on technologies such as but not limited to, data compression, data backup, data redundancy, deduplication, error correction, data fingerprinting, role-based access control, and so on.

Those skilled in the art will appreciate that the present disclosure has broad utility and application.

A system of web components interaction and data updating comprises one or more processors, one or more computer-readable memories, one or more computer-readable storage mediums, and program instructions stored on at least one of the one or more computer-readable storage mediums for execution by at least one of the one or more processors via at least one of the computer-readable memories, comprising program instructions to establish a connection between the at least one server and the at least two web components which are configured to transfer data to the server and receive responses from the server using WebSocket computer communications protocol, program instructions to send messages with updated data from server to each of the web components after the data change at the at least one of the web components.

Embodiments of the present invention may comprise at least two web components which may be a part of at least one widget. Web components may be generated or provided by remotely hosted applications, including remotely hosted software provided as a service (SaaS) applications. For example, the back-end applications may operate as a SaaS, providing application data on-demand from one or more customer relationship management (CRM) data, financial management data, project management data, supply management data, supplier relationship management data, human resources management data, executive management support data, compliance management data, enterprise resource planning (ERP) data or other data.

Those skilled in the art will appreciate that the invention comprises using the technology of Web Components which allows to create of reusable custom elements with their functionality encapsulated away from the rest of the code and utilize them in the web applications. The technology of web components may consist of three main technologies, such as Custom elements, Shadow DOM, and HTML templates, which can be used together to create versatile custom elements with encapsulated functionality that can be reused wherever you like without fear of code collisions.

Web components may be a set of web platform APIs that allow you to create new custom, reusable, encapsulated HTML tags to use in web pages and web apps. Custom components and widgets build on the Web Component standards, can work across modern browsers.

In the embodiments of the invention, the web components may be performed either independently or as a part of a widget or software application.

Embodiments of the present invention may be performed in a Software as a service (SaaS) cloud-based software delivery model in which the cloud provider develops and maintains cloud application software, provides automatic software updates, and makes software available to its customers via the internet.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiments. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiments.

In some embodiments, the web component and/or widget may be configured to access a software as a service (SaaS) based resource of the server, infrastructure as a service (IaaS), workspace as a service (WaaS), or platform as a service (PaaS).

As shown in FIG. 1, a system of web components interaction and data updating, according to some embodiments, comprises at least two web components, web component A 101 of widget 105 and web component B 102 of widget 106, and server 103 wherein server is configured for establishing the connection 104 with web components 101 and 102 which are configured to transfer data to the server and receive responses from the server using WebSocket computer communications protocol. Web components are configured to connect with server and work across various environments and various browsers.

Program instructions of the system are configured to send messages with updated data from the server to each of the web components after the data change in at least one of the web components.

In some embodiments of the invention, user 107 may create the data change at the widget 105 and then the changed data is transferred to server 103 using a computer communications protocol, for example, HTTP protocol. Server 103 is configured to execute the algorithm and transfer the result of the algorithm execution to widget 106 using the WebSocket computer communications protocol.

According to further embodiments of the invention, server 103 is configured to establish a two-way interactive communication session with widget 105 by WebSocket computer communications protocol and the web components 101 and 102 are configured to send messages to server 103 and receive responses wherein server 103 is configured to send messages with updated data to each of the web components after data change at the at least one of the web components.

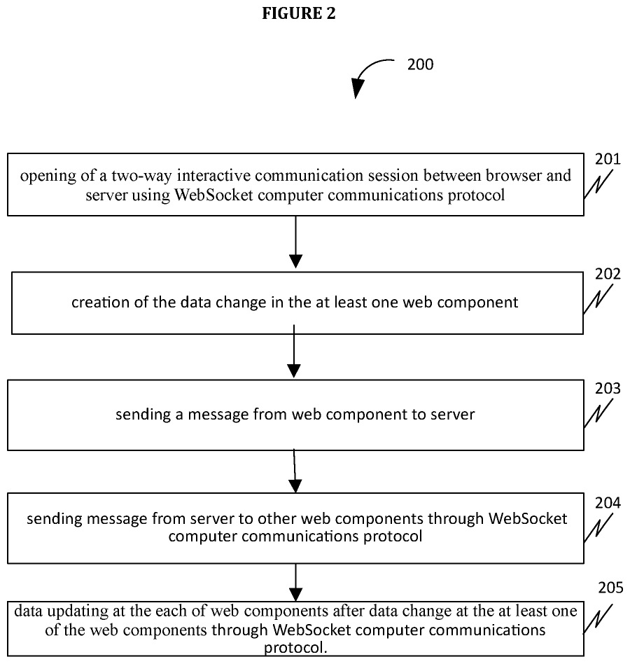

FIG. 2 illustrates one of the embodiments of method 200 which comprises the opening of a two-way interactive communication session between browser and server using WebSocket computer communications protocol 201. A user creates the data change in at least one web component 202. Further, the method comprises the step of sending a message from a web component to server 203, sending a message from a server to other web components through WebSocket computer communications protocol 204, and data updating at the each of web components after the data change at the at least one of the web components using WebSocket computer communications protocol 205.

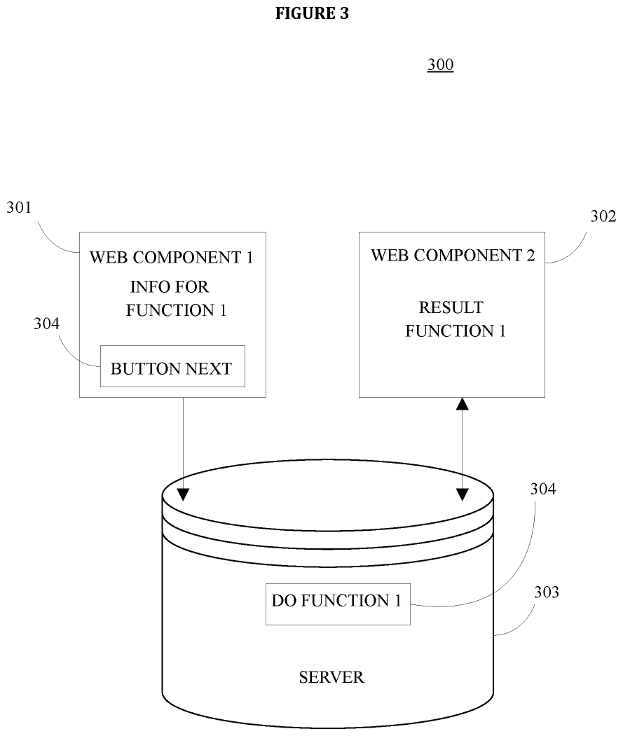

FIG. 3 illustrates a flowchart of a computer-implemented method 300 of web components interaction and data updating at a computer system in a computer networking environment, the method comprising the creation of the data change at the in the at least one web component 301 wherein web components 301 and 302 are connected to the server 303. The method further comprises transferring data from the web component 301 to server 303, executing algorithm 304 at server 303, and transferring the result of algorithm execution from server 303 to the other web component 302 using WebSocket computer communications protocol.

In some embodiments of the invention, the data change in at least one web component may be created by at least one user by pressing button 304. Transferring updated data from the web component 301 to server 303 may be performed using the HTTP protocol. The method further comprises executing the algorithm using the processing device at server 303, wherein the algorithm is configured to update data at server 303, transferring the algorithm result from the server to another web component 302 using WebSocket computer communications protocol.

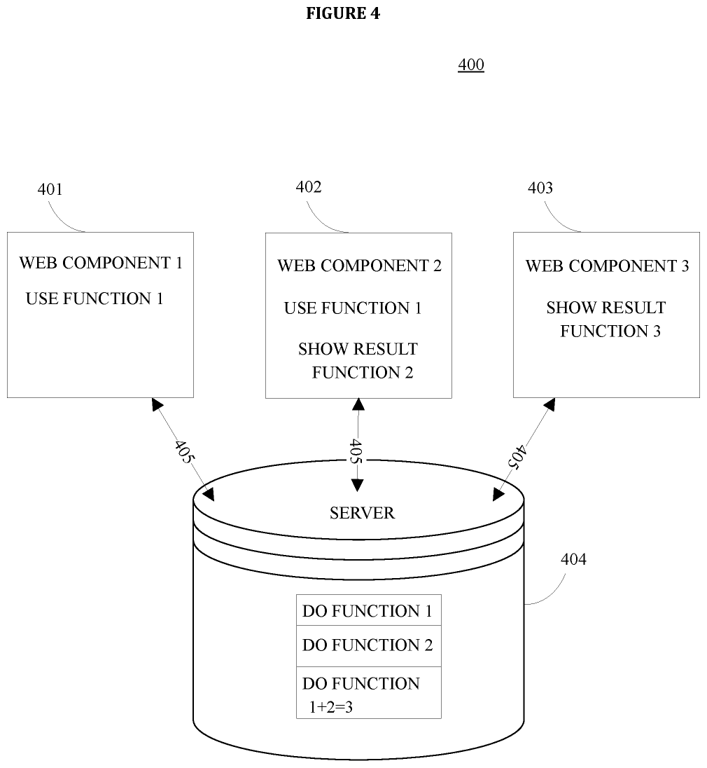

FIG. 4 illustrates one of the embodiments of method 400 comprising updating of data in at least one of the web components 401, 402, or 403 which are connected to server 404, transferring updated data from the web component 401 to server 404, establishing of a two-way interactive communication session 405 between web component and server by WebSocket computer communications protocol, creation of data change in the at least one web component, sending a message with updated data from web component 401 to server 404 and receiving responses from server 401 to web components 401, 402 or 403.

In the embodiments of the invention, the data is updated at each of web components 401, 402, or 403 using WebSocket computer communications protocol after data change in at least one of the web components.

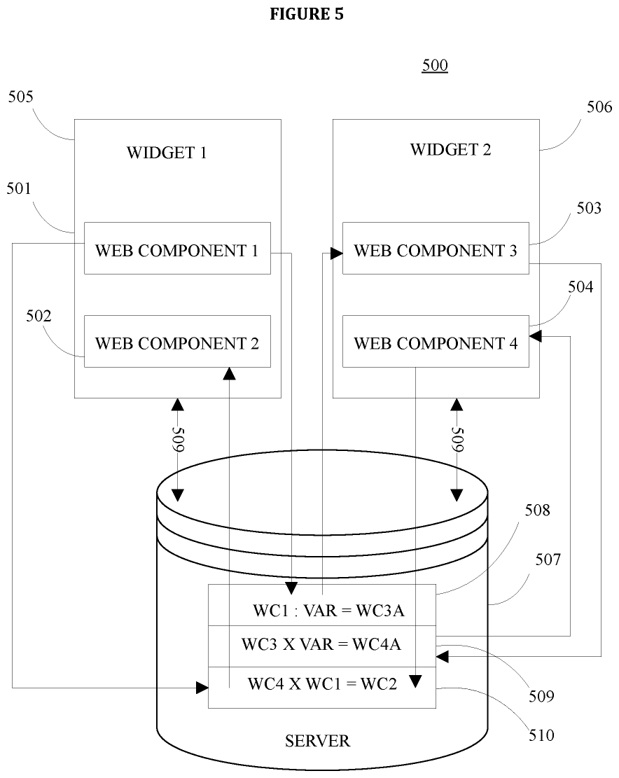

FIG. 5 illustrates one of the embodiments of the method 500 which comprises establishing a two-way interactive communication session 509 between server 505 and widgets 505 and 506 using WebSocket computer communications protocol; configuring of the web components 501, 502, 503 and 504 for listening to the server 507, creation the data change in the web component 501 of widget 505, transferring of data from the web component 501 to block 508 of server 507, executing of the algorithm using the processing device at the block 508 of server 507, transferring of the result of algorithm execution from block 508 to another web component 503 of widget 506, processing in widget 506 the result of algorithm execution received from block 508, identifying by web component 503 that received data is a result of execution of algorithm received from the block 508 and the data for execution of the algorithm is received from the web component 501 using a unique identification key, transferring the data from web component 503 to the block 509 of server 507, executing of the algorithm using the processing device at the block 509 of server 507, transferring of the result of algorithm execution from block 509 to web component 504 of widget 506, processing in widget 506 the result of algorithm execution received from block 508, identifying by web component 504 that received data is a result of execution of algorithm received from the block 509 using a unique identification key, transferring the data from web component 504 to the block 510 of server 507, executing of the algorithm using the processing device at the block 510 of server 507, transferring of the result of algorithm execution from block 510 to web component 502 of widget 505.

FIG. 6 is a circuit diagram of one aspect of a computing system/device/controller 1000 that works in conjunction with the elements of the present disclosure. In a very basic configuration of computing device 1000, the computing device 1000 typically includes one or more processors 1010 and a system memory 1020. A memory bus 1030 can be used for communications between the processor 1010 and the system memory 1020.

Depending on the desired configuration, the one or more processor 1010 of computing device 1000 can be of any type including but not limited to a microprocessor, a microcontroller, a digital signal processor, or any combination thereof. Processor 1010 can include one more levels of caching, such as a level one cache 1011 and a level two cache 1012, a processor core 1013, and registers 1014. The processor core 1013 can include an arithmetic logic unit (ALU), a floating point unit (FPU), a digital signal processing core (DSP Core), or any combination thereof. A memory controller 1015 can also be used with the processor 1010, or in some implementations the memory controller 1015 can be an internal part of the processor 1010.

Depending on the desired configuration, the system memory 1020 can be of any type including but not limited to volatile memory (such as RAM), non-volatile memory (such as ROM, flash memory, etc.) or any combination thereof. System memory 1020 typically includes an operating system 1021, one or more applications 1022, and program data 1024. Application 1022 includes an authentication algorithm 1023. Program Data 1024 includes service data 1025.

Computing device 1000 can have additional features or functionality, and additional interfaces to facilitate communications between the basic configuration 1001 and any required devices and interfaces. For example, a bus/interface controller 1040 can be used to facilitate communications between the basic configuration 1001 and one or more data storage devices 1050 via a storage interface bus 1041. The data storage devices 1050 can be removable storage devices 1051, non-removable storage devices 1052, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 1020, removable storage 1051 and non-removable storage 1052 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1000. Any such computer storage media can be part of the computing device 1000.

Computing device 1000 can also include an interface bus 1042 for facilitating communication from various interface devices (e.g., output interfaces, peripheral interfaces, communication interfaces, etc.) to the basic configuration 1001 via the bus/interface controller 1040. Example output devices 1060 include a graphics processing unit 1061 and an audio processing unit 1062, which can be configured to communicate to various external devices such as a display or speakers via one or more A/V ports 1063. Example peripheral interfaces 1070 include a serial interface controller 1071 or a parallel interface controller 1072, which can be configured to communicate with external devices such as input devices (e.g., keyboard, mouse, pen, voice input device, touch input device, etc.) or other peripheral devices (e.g., printer, scanner, etc.) via one or more I/O ports 1073. An example communication device 1080 includes a network controller 1081, which can be arranged to facilitate communications with one or more other computing devices 1090 over a network communication via one or more communication ports 1082. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

It should be noted that the specifying circuit 112, the buffer specifier 114, the segmenter 311, the transformer 312, the periodogram computer 313, the delay assessment circuit 118, the pre-processors 110 and 111, the first and second threshold circuit 130 and 131, and/or the first and the second shift register 150, 151 may work in conjunction with computing device 600. In addition, it should be noted that the specifying circuit 112, the buffer specifier 114, the segmenter 311, the transformer 312, the periodogram computer 313, the delay assessment circuit 118, the pre-processors 110 and 111, the first and second threshold circuit 130 and 131, and/or the first and the second shift register 150, 151 may be comprised directly of the elements of computing device 1000 (i.e., elements 1010 and/or 1020).

Computing device 1000 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1000 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware. The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry our part or all of the method variations discussed above. Such variations are not to be regarded as departure from the spirit and scope of the invention, and all such modifications as would be obvious to one skilled in the art are intended to be included within the scope of the following claims.

In this specification the terms “comprise,” “comprises,” “comprised,” “comprising” and the like and the terms “include,” “includes,” “included,” “including” and the like are all deemed totally interchangeable and should be afforded the widest possible interpretation.

1. A system of web components interaction and data updating, the system comprising:
one or more processors,
one or more computer-readable memories,
one or more computer-readable storage mediums,
at least one server configured to establish a connection with web components and program instructions stored on at least one of the computer-readable storage mediums for execution by at least one of the processors via at least one of the computer-readable memories,
the program instructions to transfer data from the web components to the server and receive responses from the server using WebSocket computer communications protocol, and
the program instructions to send messages with updated data from the server to each of the web components after the data change in the at least one of the web components or at least one of the servers.

2. The system according to claim 1, wherein program instructions are configured to identify web components, to identify the result of the execution of algorithm received from identified web component, and web components are configured to update data only after identifying that updated data is a result of execution of identified algorithm received from identified web component.

3. A method of web components interaction and data updating at a computer system in a computer networking environment, the method comprising:
establishing a connection between the at least one server and the at least one of the web components,
creation of data change at the at least one of the web components,
transferring updated data from the at least one of the web components to the server, and
transferring data from the server to the at least one of another web components using WebSocket computer communications protocol.

4. The method according to claim 3 comprising:
establishing a two-way interactive communication session between web components and server by WebSocket computer communications protocol,
creation of data change in the at least one web component, and
sending a message with updated data from the web component to the server and receiving responses from the server to the web component wherein data is updated at each of the web components using WebSocket computer communications protocol after data change at the at least one of the web components.

5. The method according to claim 3 further comprising:
entering data at the at least one of the web components by at least one User,
creating the data change in the at least one web component,
transferring of updated data from at least one of the web components to the server using the HTTP protocol,
executing of the algorithm using the processing device at the server, wherein the algorithm is configured to update data at the server, and
transferring of the algorithm result from the server to another web component using WebSocket computer communications protocol.

6. The method according to claim 5 further comprising:
creation the data change in the at least one web component by at least one User, and
receiving the updated data wherein data is received by at least one of the another user which is using the same web component.

7. The method according to claim 3 further comprising:
entering data at the at least one of the web components by at least one User,
creation the data change in the at least one web component, and
executing of the algorithm using the processing device at the server, wherein the algorithm is configured to retrieve data of each of the web component's data change and transfer updated data to all of other web components using WebSocket computer communications protocol.

8. The method according to claim 3 further comprising:
configuring of the web components for listening to the server,
wherein identification of the web components is carried out and each of the web components is configured to receive the data only after identifying that updated data is a result of execution of identified algorithm received from identified web component.

9. The method according to claim 7, wherein identification of the web components is carried out with a unique identification key.

10. The method according to claim 7 further comprising:
executing of the algorithm using the processing device,
transferring of the result of algorithm execution to the web component of the widget,
processing the result of algorithm execution received from the identified block of the server, and
identifying by web component that received data is a result of the execution of the algorithm received from the identified block of the server and the data for the execution of the algorithm is received from the identified web component.

11. The method according to claim 9, wherein identification of the web components is carried out with a unique identification key.

12. The method according to claim 8, wherein the identification key is generated at the frontend side and transmitted to the backend side using WebSocket computer communications protocol.

13. The method according to claim 10, wherein the identification key is generated at the frontend side and transmitted to the backend side using WebSocket computer communications protocol.

14. The method according to claim 9 further comprising: performing data-exchange between all web components in real-time.

15. The method according to claim 3, wherein web components are configured to connect with the server and work across various environments and various browsers.

16. The method according to claim 9, wherein one WebSocket connection is used for two or more widgets.

17. The method according to claim 9, wherein a WebSocket connection is established with each of the two or more widgets.

18. The method according to claim 3, wherein said method is a computer-implemented method.

19. A method of web components interaction and data updating at a computer system in a computer networking environment, the method comprising:
establishing a connection between the at least one server and the at least one of the web components,
creation of data change at the at least one of the web components,
transferring updated data from the at least one of the web components to the server,
transferring data from the server to the at least one of another web components using WebSocket computer communications protocol,
establishing a two-way interactive communication session between web components and server by WebSocket computer communications protocol,
creation of data change in the at least one web component, and
sending a message with updated data from the web component to the server and receiving responses from the server to the web component wherein data is updated at each of the web components using WebSocket computer communications protocol after data change at the at least one of the web components,
entering data at the at least one of the web components by at least one User,
transferring of updated data from at least one of the web components to the server using the HTTP protocol,
executing of the algorithm using the processing device at the server, wherein the algorithm is configured to update data at the server, and
transferring of the algorithm result from the server to another web component using WebSocket computer communications protocol.
receiving the updated data wherein data is received by at least one of the another user which is using the same web component,
configuring of the web components for listening to the server,
wherein identification of the web components is carried out and each of the web components is configured to receive the data only after identifying that updated data is a result of execution of identified algorithm received from identified web component,
wherein identification of the web components is carried out with a unique identification key,
executing of the algorithm using the processing device,
transferring of the result of algorithm execution to the web component of the widget,
processing the result of algorithm execution received from the identified block of the server,
identifying by web component that received data is a result of the execution of the algorithm received from the identified block of the server and the data for the execution of the algorithm is received from the identified web component, and
wherein the identification key is generated at the frontend side and transmitted to the backend side using WebSocket computer communications protocol.

20. A non-transitory computer readable medium having instructions stored thereon, such that when the instructions are read and executed by one or more processors, said one or more processors is configured to perform the method according to claim 3.
